(19) United States
(12) Patent Application Publication
(10) Pub. No.: US 2012/0233447 A1
(43) Pub. Date: Sep. 13, 2012

(54) Systems and Methods Providing Data Module and Processing Platform Integration

(75) Inventor: Patrick N. Fitzgerald, Noblesville, IN (US)

(73) Assignee: RAYTHEON COMPANY, Waltham, MA (US)

(21) Appl. No.: 13/045,324

(22) Filed: Mar. 10, 2011

(51) Int. Cl. G06F 9/00

(52) U.S. Cl. 713/1

(57) ABSTRACT

A system includes a data module with a data bus interface to a host processing platform. The data module has a data resource hardware component, and a non-volatile memory storing an Operating System (OS) image. The non-volatile memory is in communication with the data bus interface to the host processing platform. The OS image, when executed by the processing platform, exposes a control Application Programming Interface (API) thereby providing access to the data resource hardware component.

### BACKGROUND

Modern defense platforms rely heavily on a wide variety of sensors, communications links, processing elements, data busses, and human interface elements to collect, manipulate, collate, disseminate, retrieve, and store many different types of information. These elements work together to provide the end users an integrated representation of the mission field.

Although different missions have widely varying requirements for the types and uses of sensors, there are many common elements in their sensor integration needs. As data processing and fusion techniques advance in sophistication, the output becomes more valuable to the end user. At the same time, complexity in processing drives up development costs as well as processor needs. Different sensors often present very different interfaces to the platform as well, requiring complicated conversion and costly interfacing.

A current approach to sensor integration provides a centralized processor within a server. The server has an Operating System (OS) and software applications running on top of the OS, where each of the software applications provide for sensor data retrieval and sensor control. The applications communicate directly with the sensor. In another approach, the sensor hardware modules have their own processors and software/firmware that communicate directly with the server OS via Application Programming Interfaces (APIs). The server and the modules have knowledge of each other's operating characteristics and are, therefore, strongly coupled. Strong coupling has some advantages, including lower communication overhead and processing power usage because each entity communicates directly with the other in a manner that the other expects and understands. However, strong coupling also has a lack of flexibility. For instance, a change in the operating characteristics of a module may require a change in the code at the server, e.g., by loading updated software on the server to communicate properly with the module. New architectures for module/server integration would be desirable.

### BRIEF DESCRIPTION OF THE DRAWINGS

Aspects of the present disclosure are best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is an illustration of an exemplary deployed system adapted according to one embodiment.

FIG. 2 is an illustration of an exemplary processing platform/data module system, which shows one example of how the processing platform and data modules of FIG. 1 may be implemented.

FIG. 3 is an illustration of exemplary hardware for use in the system of FIG. 2.

FIG. 4 is an illustration of exemplary software/hardware functionality for use in the system of FIG. 2.

FIG. 5 illustrates conceptually that the host processing platform can be scaled by increasing or enhancing its available CPU power, memory, bandwidth, and number of physical slots for modules.

FIG. 6 illustrates that the host processing platform can be scaled down.

FIG. 7 shows an example cluster.

FIG. 8 is an illustration of an exemplary system adapted according to an embodiment wherein data modules communicate over a WAN.

FIG. 9 is an illustration of an exemplary method for using a system, such as the system of FIG. 2.

### DETAILED DESCRIPTION

The present disclosure provides a new architecture for integrating capability modules with processing platforms. Many of the examples below refer to sensor modules in a military application. However, it is understood that embodiments may be adapted to any kind of module (e.g., data storage, communications, sensors, etc) for consumer, commercial, and/or military use.

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Various embodiments include a scalable, dynamic, and adaptive architecture for rapid integration of multiple sensors, communications systems, and processing elements on a variety of platforms, using loose coupling/Service Oriented Architecture (SOA) methods for data exchange between elements and a processor virtualization approach to reduce production and engineering costs on individual elements. In one example, the architecture implements a “plug-and-play” concept for adding new elements to the system, allowing users of existing and new platforms to easily select common sensor elements from a catalog, rapidly integrate legacy sensor systems using compatibility modules, and customize the capabilities of a platform on a per-mission basis.

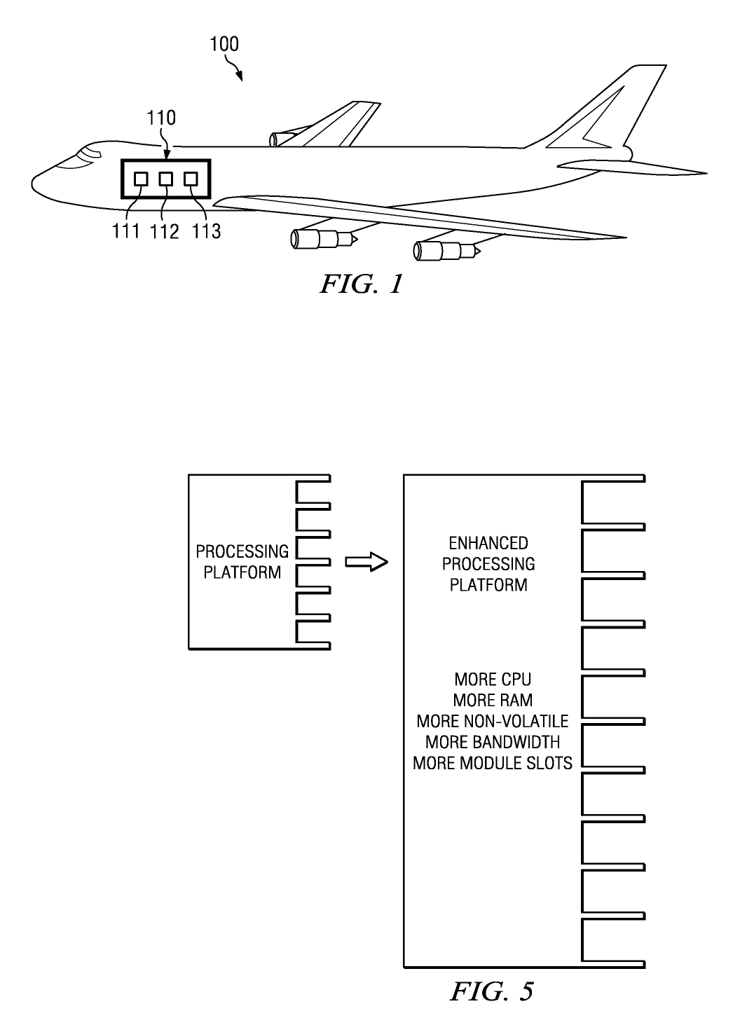

FIG. 1 is an illustration of exemplary deployed system 100 adapted according to one embodiment. System 100 in this example includes an aircraft, though it is understood that other embodiments may include other deployment modalities, such as land vehicles, nautical vessels, space vehicles, stand-alone systems, deployable or permanent installations, an Unmanned Aerial Vehicle (UAV), and the like.

System 100 includes processing platform 110, which may include any of a variety of processor-based devices. Examples of devices that can be used as processing platforms include personal computers, server computers, super computers, handheld devices, ASIC-based devices, and the like. Processing platform 110 is in communication with data modules 111-113, each of which adds a specific functionality that is utilized by processing platform 110. Examples of different types of data modules are more fully described below, but in one example, data modules 111-113 include sensors. Processing platform 110 processes and analyzes the data from the sensors and also runs applications that control operation of the sensors.

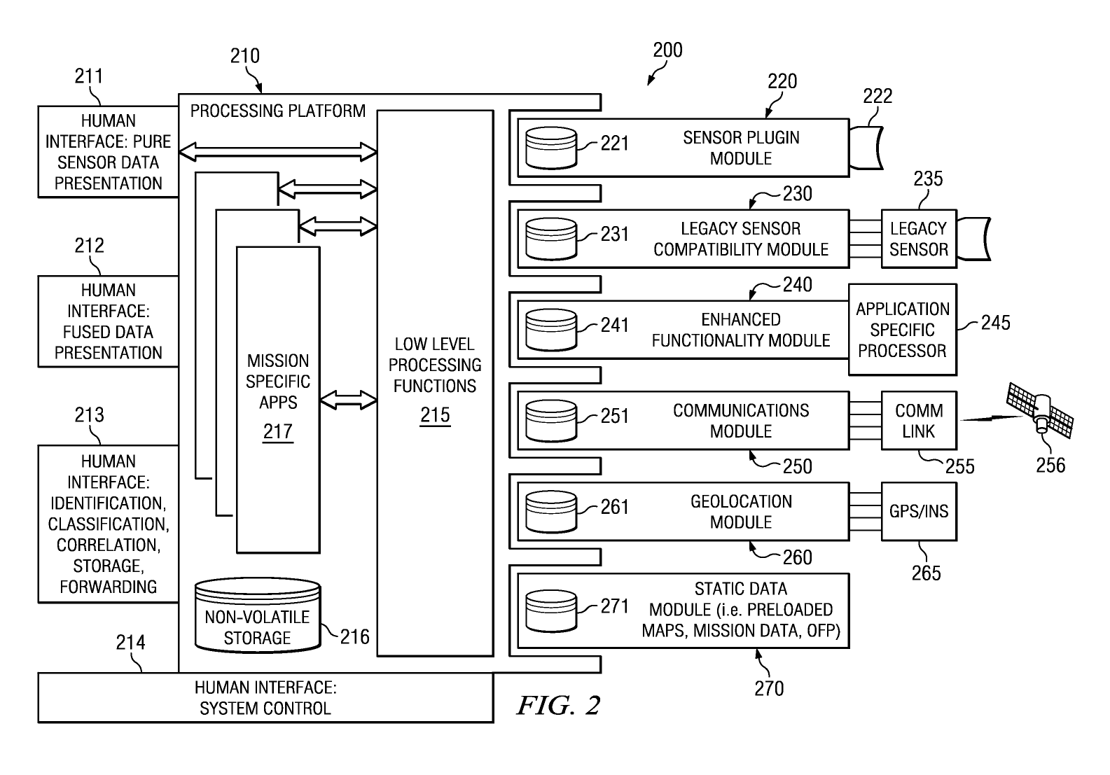

FIG. 2 is an illustration of an exemplary processing platform/data module system 200, which shows one example of how processing platform 110 and data modules 111-113 (FIG. 1) may be implemented. With reference to FIG. 2, the architecture includes processing platform 210 which acts as host to a variety of data modules 220, 230, 240, 250, 260, and 270. Processing platform 210 provides processing capability to mission applications as well as to data modules 220, 230, 240, 250, 260, and 270. Processing platform 210 also provides interconnections between data modules 220, 230, 240, 250, 260, and 270.

Processing platform 210 hosts a processor virtualization platform which allows multiple guest operating systems to run on one physical host. Examples of virtualization platforms include, but are not limited to, software platforms marketed under the names MS VIRTUAL SERVER™ and VM WARE™, each of which can be installed in processing platform 210 and used as described further below. In the present example, the virtualization platform runs operating system images of each of respective data modules 220, 230, 240, 250, 260, and 270 in their own environments-separate from each other and separate from the processing platform OS too.

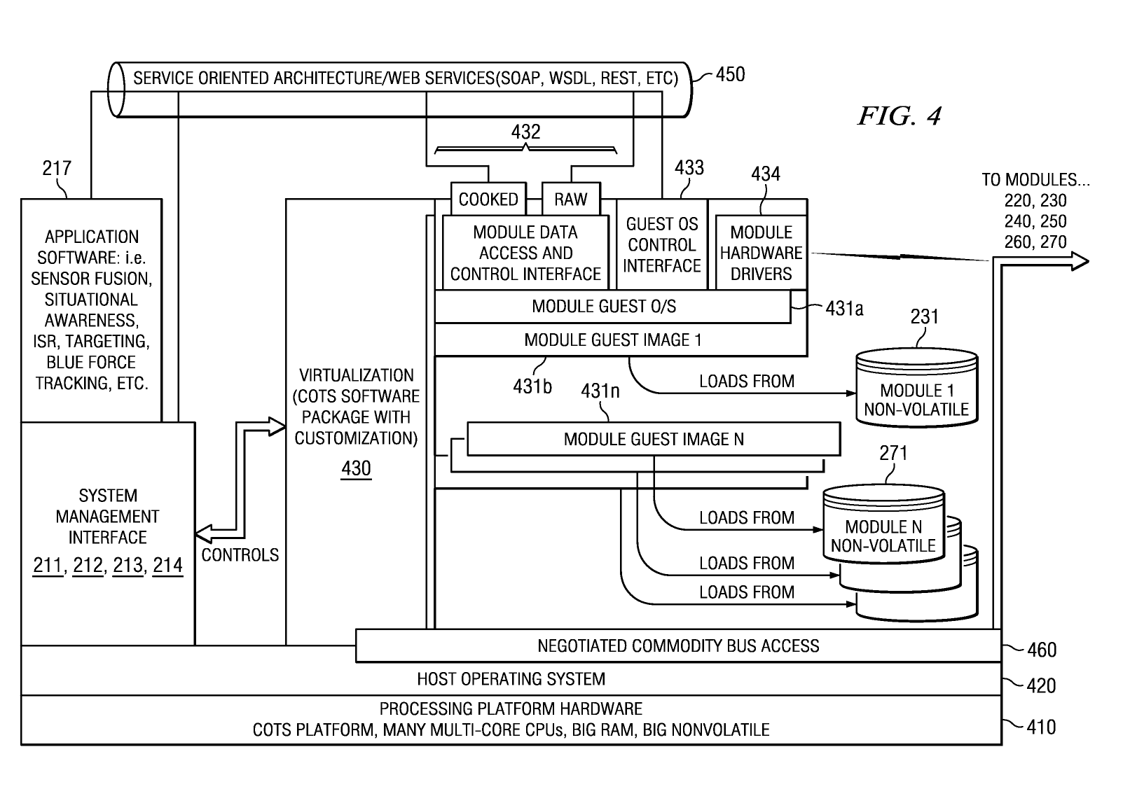

Data modules 220, 230, 240, 250, 260, and 270 connect to processing platform 210 using a commodity digital data bus, such as IEEE1394, USB, 10 GBit 100 Mbit or 10 Mbit Ethernet, eSATA, MIL-STD-1553, Fibre Channel, Light Peak, PoE, etc. Furthermore, each of data modules 220, 230, 240, 250, 260, and 270 contains a non-volatile storage medium 221, 231, 241, 251, 261, and 271. Each of the storage media 221, 231, 241, 251, 261, and 271 includes a module guest image, which in this example is a complete operating system configuration suitable to be run within the virtualization platform of processing platform 210. Each module guest image exposes a common module control Application Programming Interface (API) providing access to module initialization, power control, configuration, and the like. In addition, each respective module guest image exposes a module-specific API that provides access to data functions unique to that module. The APIs are exposed through Service-Oriented Architecture (SOA) using Web Services implemented with industry standards, such as Simple Object Access Protocol (SOAP), Web Services Description Language (WSDL), Representational State Transfer (REST), etc. (as shown in FIG. 4).

When a given module is connected to processing platform 210, the guest image is uploaded and run within the virtualization platform. The bus connecting the data modules 220, 230, 240, 250, 260, and 270 to processing platform 210 is then handed off to the newly running guest image, which can then access the hardware components of the data module. The original guest image is preserved on the module to facilitate fault recovery. For example, if the guest image experiences a critical software failure processing platform 210 can simply refresh the guest image from the module. The running guest image can also be stored into the module's non-volatile memory 216, allowing the module to preserve state across multiple missions. Multiple stored guest images allow for multiple module operational profiles, which can be stored and restored according to the operator's desires. The particular combination of modules for the mission can be selected and installed on the platform as desired.

Further in this example, modules 220, 230, 240, 250, 260, and 270 share a common underlying hardware/software architecture so that the platform can be reconfigured dynamically to fit the user's needs. With appropriate design considerations, modules can be made hot-swappable for rapid fault recovery. Typical design considerations for hot-swap operation include hardware power control within the module, hot-swap capable data bus selection, and connector modalities suitable for connect and disconnect while energized.

Various embodiments can include any of a variety of data module types. One data module type is embodied by sensor module 220. Sensor module hardware includes non-volatile memory element 221 (e.g., a hard drive, flash memory, or the like), physical sensor element 222, and the interface components (not shown) to transmit the raw sensor data on the data bus and configure the sensor. Non-volatile memory 221 stores a module guest image with software to export the sensor data and module control APIs.

Another data module type is exemplified by legacy compatibility module 230. Legacy compatibility module hardware includes non-volatile memory element 231 and interface components (not shown), but it does not include the sensor element itself. Rather, legacy compatibility module 230 connects to a legacy module, such as legacy sensor 235, and acts as an adaptor to facilitate integration of sensor 235 to processing platform 210. In one aspect, legacy compatibility module 230 serves as “glue” between fusion server 210 and other industry standard interconnects. An example of a legacy module is a module that provides an analog video interface. In such an example, legacy compatibility module 230 may provide an analog video input and control hardware/software compatible with legacy module 235. The concept of legacy compatibility can be extended to any type of legacy data module. Legacy compatibility module 230 can be used to retrofit system 200 to a deployed system (e.g., a UAV) that has legacy sensors. Specifically, the existing sensors can be accommodated using legacy compatibility module 230 as described above. In fact any application can be retrofitted with new and/or old sensors using system 200.

Processing platform 210 provides a general purpose processing facility for modules 220, 230, 240, 250, 260, and 270 in the system. Many applications, however, use specific types of processing systems. Enhanced functionality module 240 encapsulates additional processing capabilities and provides them to the system. In one example enhanced functionality module 240 provides a bank of specialized Digital Signal Processors (DSPs) to the system where the DSPs can be used to process data from other modules or server applications. Thus, data communication is two-way between processing platform 210 and module 240. Enhanced functionality module 240 may also be used to integrate new processor technologies (e.g., quantum processors, extended analog computing) into the system as they are developed.

Communications module 250 is used to interface the system to data links. In many instances, communication interface functions can be accomplished without the complexity and overhead of a full module by using built-in communications capabilities of processing platform 210. However, in some scenarios additional capabilities may be desired. For instance, a communications module 250 may be used to buffer data in preparation for sending across a sporadic link or to provide extra control input/output for unique communication link systems such as with satellite 256.

Geolocation/navigation module 260 provides standard functions for interfacing with existing and future geolocation systems, such as satellite-based (i.e. GPS, Galileo) 265, an inertial navigation, or an astronavigation system.

Static data module 270 provides removable bulk storage to the system. In one example, static data module 270 is used for storage of map data, imagery, mission plans, additional mission software, and other pre-mission data loads. Static data module 270 can also be used to store data gathered on a mission for later dissemination and processing and could be used by other modules for temporary data storage space.

The data module types listed above are not intended to be exhaustive. On the contrary, it is expected that other types of data modules may be developed and deployed to take advantage of the architecture disclosed herein.

Low-level processing functions 215 include, for example, functions to interface with the hardware busses. Mission Specific applications 217 include applications that can be used to control modules 220, 230, 240, 250, 260, and 270 and also to receive, transmit, and process module data. One exemplary application provides fusion of data from multiple modules (e.g., by overlaying geolocation data on to video). Applications 217 interact with modules 220, 230, 240, 250, 260, and 270 through exposed APIs, as explained above. Non-volatile storage 216 can be used to store a server OS image, a guest image, and/or any other appropriate information.

Processing platform 210 also includes human interfaces 211-214. The interfaces 211-214 allow a human user to see processed data and to control the operation of system 200. In one example, an interface displays data on a screen. In another example, an interface allows a human user to start up, shut down, add, or remove a data module. Examples of human interface devices include computer monitors, keyboards, pointing devices, touch screens and the like.

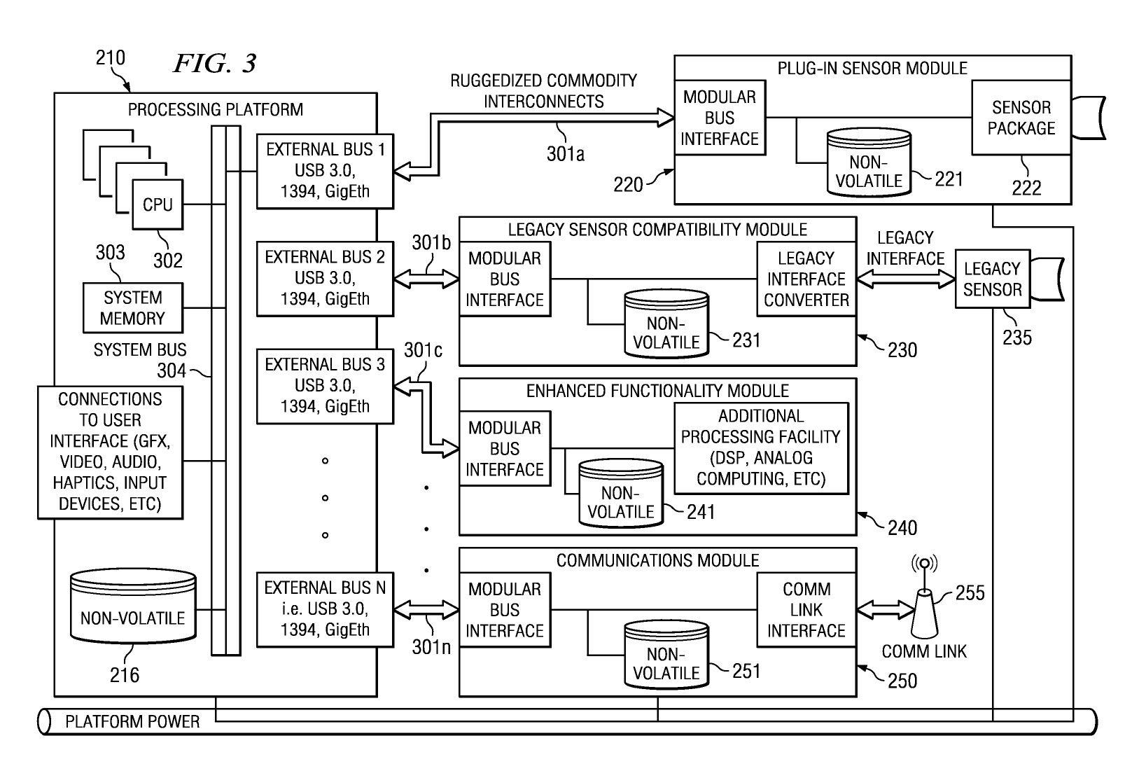

FIG. 3 is an illustration of exemplary hardware for use in system 200 (FIG. 2). Many of the features discussed in FIG. 2 are shown in FIG. 3 and, for convenience, will not be described again. Of note in FIG. 3 are interconnects 301, which in this example are ruggedized commodity interconnects but could be any kind of interconnect. Examples include USB cables, Cat 5 cables, and the like.

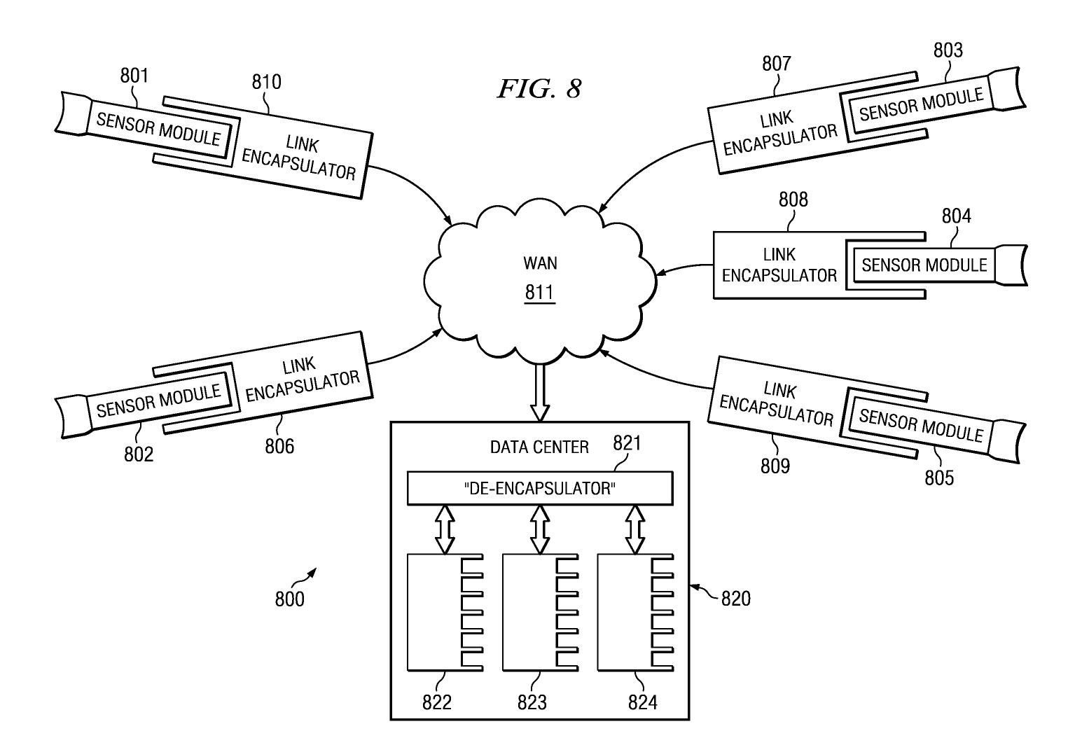

Central processing unit (CPU) 302 is coupled to system bus 304. CPU 302 may be any general purpose or specialized purpose CPU. However, the scope of embodiments is not restricted by the architecture of CPU 302 as long as CPU 302 supports the inventive operations as described herein. CPU 302 may execute the various logical instructions according to embodiments disclosed herein. For example, one or more CPUs, such as CPU 302, may execute machine-level instructions according to the exemplary operations described in conjunction with FIGS. 4 and 8.

Processing platform 210 also includes random access memory (RAM) 303, which may be SRAM, DRAM, SDRAM, or the like. In this example, Processing platform 210 uses RAM 303 to store a guest image as the guest image is being executed. Processing platform 210 also includes non-volatile memory 216 which may be PROM, EPROM, EEPROM, or the like. RAM 303 and non-volatile memory 216 hold user and system data and programs, as is well known in the art.

FIG. 4 is an illustration of exemplary software/hardware functionality for use in system 200 (FIG. 2). Processing platform hardware 410 includes many of the components discussed with respect to FIG. 3. The CPU runs Host OS 420, which provides an environment to run mission specific applications 217 and code for system management interfaces 211-214.

Host OS 420 provides virtualization platform 430, where guest images 431 are run in virtualized environments. Virtualization platform 430 provides an environment wherein each of guest images 431 “thinks” it is being run on compatible hardware but actually only communicates with software processes of virtualization platform 430. The environment for each guest image 431 is isolated from host OS 420; or in other words, guest images 431 communicate with platform 430 rather than directly with OS 420 and are “unaware” of OS 420. Thus, each guest image 431 is given a virtualized system all its own.

As guest images 431 are executed, they expose APIs 432, 433. APIs 433, 434 are exposed as network transportable services to applications 217 and interfaces 211-214 using standard network protocols. One example of network transportable services is Web Services, through the scope of embodiments is not limited just to Web Services. The system implements a Service Oriented Architecture (SOA) 450 to provide services among modules 220, 230, 240, 250, 260, and 270, applications 217, and interfaces 211-214. Drivers 434 are also executed and exposed as appropriate.

As shown above, modules 220, 230, 240, 250, 260, and 270 are loosely coupled to processing platform 210. The functionality of modules 220, 230, 240, 250, 260, and 270 is distributed using network transportable services in SOA 450, so that applications 217 do not directly communicate with modules 220, 230, 240, 250, 260, and 270. Also, modules 220, 230, 240, 250, 260, and 270 do not directly interact with host OS 420, but rather communicate with the guest images 431 using bus access 460.

One advantage provided by the architecture shown in FIG. 4 is that a software failure in one of the guest images 431 is unlikely to affect host OS 420 or other guest images. In this way, module failures are much less likely to lead to system failures. Also, a module can be brought back on line quickly by re-uploading its respective guest image. Other advantages are discussed in more detail below.

In some embodiments, processing platform 210 can be scaled to fit a user's particular needs. By increasing or reducing the number of processor cores, the amount of volatile and nonvolatile memory, and the number of interconnect busses, processing platform 210 can grow or shrink to host as many or as few data modules as desired. FIG. 5 illustrates conceptually that the processing platform can be scaled by increasing or enhancing its available CPU power, memory, bandwidth, and number of physical slots for modules. A given processing platform can be scaled by a manufacturer during production or even by customers when modular parts are used.

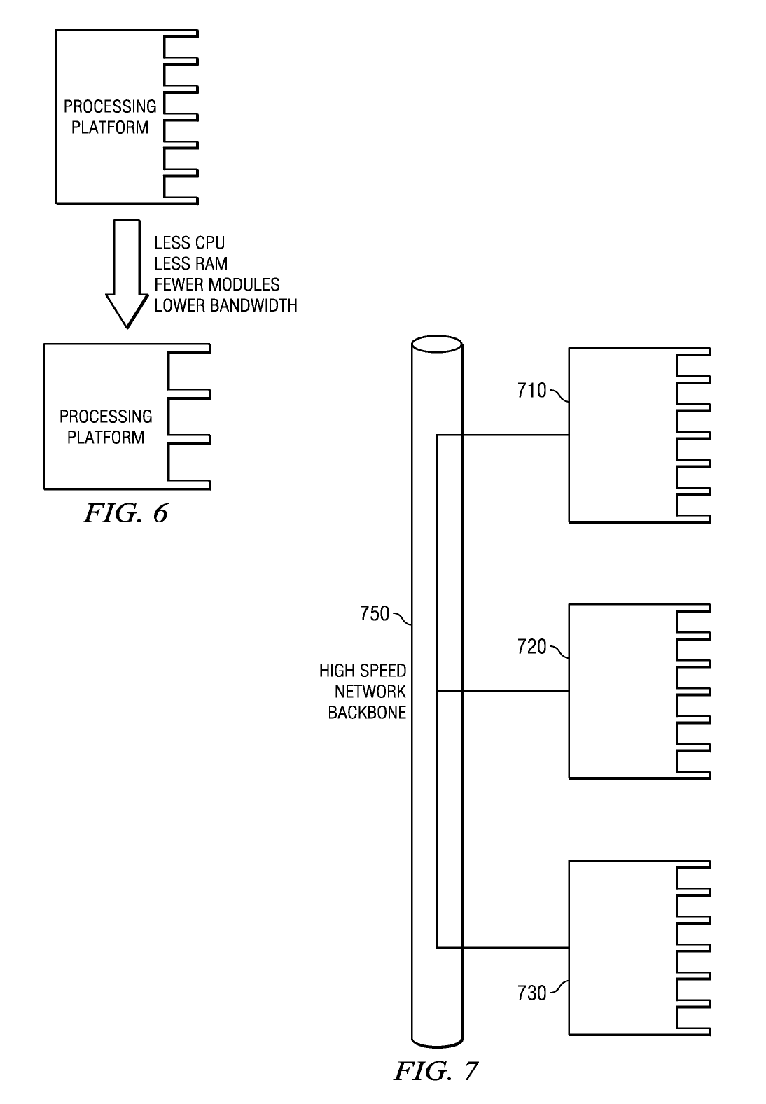

FIG. 6 illustrates that the processing platform can be scaled down as well. For instance, available CPU power, memory, bandwidth, and number of physical slots for modules can be reduced. Missions that benefit from more complex mission specific applications and/or have greater budgets may be candidates for scaled-up embodiments, whereas missions with simple sensor needs or smaller budgets may benefit from cost savings afforded by scaled-down embodiments. Key tradeoffs in processing platform design include: processor capability, memory capacity (volatile and nonvolatile), number of module slots/busses and additional communication/interface capabilities. Such factors are traded for size, weight, power, heat output and system cost.

Applications beyond the processing capabilities of one processing platform can be implemented using multiple processing platforms because the data modules expose their interfaces through SOA and SOA can be extended to multiple processing platforms through a network. For instance, several processing platforms can be connected together in a cluster for missions requiring more capability than one processing platform can provide. Furthermore, multiple processing platforms can act as one logical system because each module runs in its own virtualized system and the modules communicate with each other and with the mission applications through network transportable services. An example cluster is shown in FIG. 7, where three processing platforms 710, 720, 730 are connected via network 750. The APIs for the data modules (not shown in FIG. 7) are exposed over network 750, thereby distributing data module access among multiple processing platforms 710, 720, 730. Furthermore, in this arrangement, the various data modules associated with processing platforms 710, 720, 730 can share data with each other over network 750. The embodiment shown in FIG. 7 can be used to provide ever more complex mission applications than simpler systems. For instance, systems that fuse data from a multiplicity of sensors to create very sophisticated outputs may benefit from a clustered embodiment.

Other embodiments include widely distributed modules. FIG. 8 is an illustration of exemplary system 800 adapted according to an embodiment wherein data modules 801-805 each include a respective link encapsulation/decapsulation device 806-810. The link encapsulation/decapsulation devices 806-810 adapt modules 801-805 to Wide Area Network (WAN) 811 so that data and control can be sent bi-directionally among data modules 801-805 and data center 820. Data center 820 also includes link encapsulation/decapsulation device 821. The embodiment of FIG. 8 may also include a “sensor mesh” network, wherein link encapsulation/decapsulation devices 806-810 dynamically configure wireless links between each other to pass data seamlessly back to data center 820 when there is otherwise no direct connection from data center 820 to one or more data modules.

Further in the example of FIG. 8, data center 820 includes three processing platforms 822-824. Each of the processing platforms 822-824 can operate separately or can be logically combined as described with the embodiment of FIG. 7. An example deployment application for system 800 is in a long virtual fence, where the data modules 801-805 can include motion sensors, night vision cameras, visible light cameras, and the like. The data modules 801-805 are spread out over many miles and communicate with data center 820 over WAN 811.

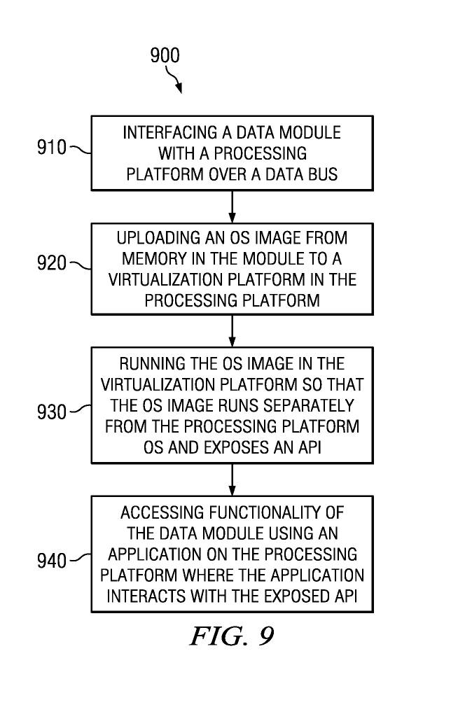

Some embodiments include methods. For instance, FIG. 9 is an illustration of exemplary method 900 for using a system, such as system 200 of FIG. 2. In one example, method 200 is performed by a system as it is being set up or configured.

In block 910, a data module is interfaced with a processing platform over a data bus. As mentioned above, the interface can be an Ethernet interface, a USB interface, an IEEE 1394 interface, or other appropriate interface. Different types of data modules are described above and can be used in this example.

In block 920, an OS image is uploaded from the data module to a virtualization platform running on the processing platform. In block 930 the OS image is run in the virtualization platform. The OS image from the data module does not interact directly with the host OS and, therefore, is run separately from the host OS. The OS image exposes one or more APIs that provide a control and/or a data connection with the data module.

In block 940, functionality of the data module is accessed using an application on the host processing platform. For instance, an application running on the host OS may communicate with the exposed API via Web Services using standard network protocols. The communication can include control information and/or data transmissions/requests.

The scope of embodiments is not limited to method 900, as other embodiments may add, omit, modify, or rearrange actions. In one example, method 900 further includes interfacing a second module (or further additional modules) with the processing platform, where each of the additional modules has an OS image that is run in a virtualization environment.

Various embodiments may include advantages over other techniques. In one aspect, system architects, module implementers, and application developers may see some benefits. The ability to easily integrate a module from a potentially large catalog into any system, whether a new or existing platform, provides the system architect a head-start in meeting a customer's needs.

In another aspect, the system virtualization “sandbox” concept effectively makes the modules future-proof—the virtualized server system presented to the module software does not change even if the underlying processing platform hardware changes significantly. The module implementer can, within the limits of the virtualization platform, work within a standalone, customized software environment, completely independent of the other modules in the system. At the same time, the application developer can easily access module functions through self-documenting interfaces presented by the modules themselves.

In yet another aspect, failed modules can be hot-swapped with replacements with a minimum of downtime. The processing platform's software can maintain health monitoring on the modules and dynamically restart subsystems as needed, even completely reloading the module's guest image from non-volatile storage at run time.

The foregoing has outlined features of several embodiments so that those skilled in the art may better understand the detailed description that follows. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. A system comprising:
a data module with a data bus interface to a host processing platform, the data module comprising:
a data resource hardware component; and
a non-volatile memory storing an Operating System (OS) image, the non-volatile memory in communication with the data bus interface to the host processing platform;
wherein the OS image, when executed by the host processing platform, exposes a control Application Programming Interface (API) thereby providing access to the data resource hardware component.

2. The system of claim 1 in which the data module comprises a sensor module.

3. The system of claim 2 in which the data resource hardware component includes a video camera.

4. The system of claim 1 in which the data module is selected from the list consisting of:
a sensor module
an adapter for a legacy device;
an auxiliary processor module;
a communications interface module;
a geo-location module; and
a data storage module.

5. The system of claim 1 in which the data bus interface comprises at least one of the following: a Universal Serial Bus (USB) interface, an IEEE 1394 bus interface, and an Ethernet interface.

6. The system of claim 1 in which the data bus interface includes a Wide Area Network (WAN) interface with an encapsulator to packetize data from the data resource hardware component.

7. The system of claim 1 included in at least one of an aircraft, a land vehicle, an Unmanned Aerial Vehicle (UAV), and a stand-alone system.

8. A system comprising:
a host processing platform with a plurality of data module interfaces, the host processing platform further comprising:
a virtualization platform that receives a first Operating System (OS) image via one of the data module interfaces and runs the first OS image independently of a host OS, the server accessing resources of a first data module through an Application Programming Interface (API) exposed by the first OS image.

9. The system of claim 8 in which the virtualization platform includes an environment that loads the OS image and runs the OS image separate from a control application for the data module, the control application for the data module running on top of the host OS.

10. The system of claim 8 in which the module interfaces comprises at least one of the following: a Universal Serial Bus (USB) interface, an IEEE 1394 bus interface, and an Ethernet interface.

11. The system of claim 8 in which the virtualization platform includes resources to run a second OS image from a second data module independently of the host OS and independently of the first OS image.

12. The system of claim 8 further comprising:
a first application configured to run within the host OS and to interact with the first OS image to control the first data module.

13. The system of claim 8 further comprising:
a human interface displaying functional options corresponding to data module functions; and
a system management interface configured to control addition and removal of the first data module.

14. The system of claim 8 in which the data module interfaces comprise Wide Area Network (WAN) interfaces and a de-encapsulator to receive communications over the WAN.

15. The system of claim 8 further comprising an additional host processing platform with an additional virtualization platform in communication with the host processing platform over a network, the host processing platform and the additional host processing platform sharing data from the first data module.

16. The system of claim 8 included in at least one of an aircraft, a land vehicle, an Unmanned Aerial Vehicle (UAV), and a stand-alone system.

17. A method for using a first data module with a first host processing platform, the method comprising:
interfacing the first data module with the first host processing platform;
uploading a first Operating System (OS) image from non-volatile memory in the first data module to a virtualization platform in the first host processing platform;
running the first OS image in the virtualization platform so that the first OS image is isolated from a host OS, the first OS image exposing an Application Programming Interface (API);
accessing data and control functionality of the first data module using a first application running on the host OS, the first application interacting with the exposed API using a standard network protocol.

18. The method of claim 17 further comprising:
interfacing a second data module with the first host processing platform;
uploading a second OS image from non-volatile memory in the second data module to a virtualization platform in the first host processing platform; and
running the second OS image in the virtualization platform so that the second OS image is isolated from a host OS and from the first OS image.

19. The method of claim 17 further comprising:
interfacing a second host processing platform with the first host processing platform over a network; and
sharing the data and control functionality of the first data module between the first host processing platform and the second host processing platform.

20. The method of claim 17 in which interfacing the first data module with the first processing platform comprises:
connecting the first data module and the first host processing platform over a Wide Area Network.
